(19) United States
(12) Patent Application Publication
(10) Pub. No.: US 2005/0099503 A1
(43) Pub. Date: May 12, 2005

(54) Image/tactile information input device, image/tactile information input method, and image/tactile information input program

(76) Inventor: Ikuaki Kitabayashi, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/463,230

(22) Filed: Jun. 17, 2003

(30) Foreign Application Priority Data
Jun. 19, 2002 (JP) 2002-178626

(51) Int. Cl. H04N 5/232

(52) U.S. Cl. 348/211.99

(57) ABSTRACT

An image/tactile information input device includes a camera imaging and capturing object image information as an electronic image, and a tactile glove for touching at least part of the object to capture tactile information. The camera produces associating information associating the image information with the tactile information so that the image position of a particular part of the imaged object and the tactile sense at the position correspond to each other, and generates image information with tactile information including the image information, the tactile information, and the associating information.

### DETAILED DESCRIPTION OF THE INVENTION

1. Field of the Invention

The present invention relates to an image/tactile information input device, an image/tactile information input method, and an image/tactile information input program.

2. Related Art

For example, Japanese Patent No. 2933023 discloses a device for inputting image information, obtaining tactile information corresponding to the image from the image information, and outputting it.

The above-mentioned device, however, has a disadvantage in that accurate tactile information cannot be obtained, since the tactile information is obtained from the image information.

An object of the present invention is to provide an image/tactile information input device, an image/tactile information input method, and an image/tactile information input program, which can associate image information and tactile information of an object with each other, and obtain them accurately.

### SUMMARY

The above and other objects can be achieved by the present invention as described in the following items (1) to (16).

(1) An image/tactile information input device characterized by comprising:
image-information acquisition means to capture image information of an object by imaging the object as an electronic image;
tactile-information acquisition means to capture tactile information, which is a sense of touch, by touching at least one part of the object; and
associating-information production means for producing associating information associating the image information and the tactile information with each other so that the image position of a particular part of the object and the tactile sense at the position correspond to each other;
wherein image information with tactile information, including the image information, the tactile information, and the associating information, is produced.

(2) An image/tactile information input device as in (1), wherein
the input device obtains the position of the tactile-information acquisition part of the object when capturing the tactile information; and
the input device produces the associating information on the basis of the obtained positional information.

(3) An image/tactile information input device as in (1), wherein
the input device images the tactile-information acquisition means and the object as an electronic image by the image-information acquisition means, and obtains the position of the tactile-information acquisition part of the object on the basis of the tactile-information acquisition means and the image information of the object, when capturing the tactile information, wherein
the associating information is produced on the basis of the obtained positional information.

(4) An image/tactile information input device as in (2) or (3), wherein
the tactile-information acquisition means includes at least one position marker indicating a particular position of the tactile-information acquisition means; wherein
the position of the tactile-information acquisition part of the object is obtained using the position marker.

(5) An image/tactile information input device as in any one of (1) to (4), wherein the tactile-information acquisition means includes a plurality of pressure sensors for detecting pressure when the object is touched.

(6) An image/tactile information input device as in (5), wherein the tactile-information acquisition means includes a plurality of temperature sensors for detecting temperature when the object is touched.

(7) An image/tactile information input device according to any one of (1) to (6), wherein the tactile-information acquisition means includes a glove-shaped wearing means for wearing on a hand.

(8) An image/tactile information input device as in any one of (1) to (7), wherein the tactile information includes pressure information.

(9) An image/tactile information input device as in (8), wherein the tactile information further includes temperature information.

(10) An image/tactile information input device as in (8) or (9), wherein the tactile information further includes friction information.

(11) An image/tactile information input device as in any one of (1) to (10), wherein the image information and the tactile information are captured separately.

(12) An image/tactile information input device as in any one of (1) to (11), wherein the image information with tactile information is composed of the image information, the tactile information, and the associating information.

(13) An image/tactile information input device as in any one of (1) to (11), wherein the image information with tactile information separately includes the image information, the tactile information, and the associating information.

(14) An image/tactile information input device as in any one of (1) to (13), comprising recording means for recording the image information with tactile information.

(15) An image/tactile information input method characterized by comprising the steps of:
imaging an object to capture image information of the object as an electronic image;
touching at least one part of the object to capture tactile information, which is a sense of touch;
producing associating information for associating the image information and the tactile information with each other, so that the image position of a particular part of the object and the tactile sense at the position correspond to each other; and
producing image information with tactile information including the image information, the tactile information, and the associating information.

(16) An image/tactile information input program for operating a computer as:
image-information acquisition means for imaging an object to capture image information of the object as an electronic image;
tactile-information acquisition means to capture tactile information, which is a sense of touch, by touching at least one part of the object;
associating-information production means for producing associating information for associating the image information and the tactile information with each other, so that the image position of a particular part of the object and the tactile sense at the position correspond to each other; and
means for producing image information with tactile information including the image information, the tactile information, and the associating information.

### BRIEF DESCRIPTION OF THE DRAWINGS

FIG. 1 is a perspective view showing an image/tactile information input device according to an embodiment of the present invention.

FIG. 2 is a perspective view showing an example of the components of a camera of the image/tactile information input device shown in FIG. 1.

FIG. 3 is a block diagram showing an example of the circuitry of the camera of the image/tactile information input device shown in FIG. 1.

FIG. 4 is a perspective view showing an example of the components of a tactile glove of the image/tactile information input device shown in FIG. 1.

FIG. 5 is a block diagram showing an example of the circuitry of the tactile glove of the image/tactile information input device shown in FIG. 1.

FIG. 6 is a schematic diagram showing the palm side of the tactile glove of the image/tactile information input device shown in FIG. 1.

FIG. 7 is a schematic diagram of sensors and the periphery of the tactile glove of the image/tactile information input device shown in FIG. 1.

FIG. 8 is a flowchart showing an example of the operation of the image/tactile information input device shown in FIG. 1 when image information and tactile information are captured.

### DETAILED DESCRIPTION

An image/tactile information input device, an image/tactile information input method, and an image/tactile information input program according to the present invention will be specifically described below with reference to a preferred embodiment shown in the attached drawings.

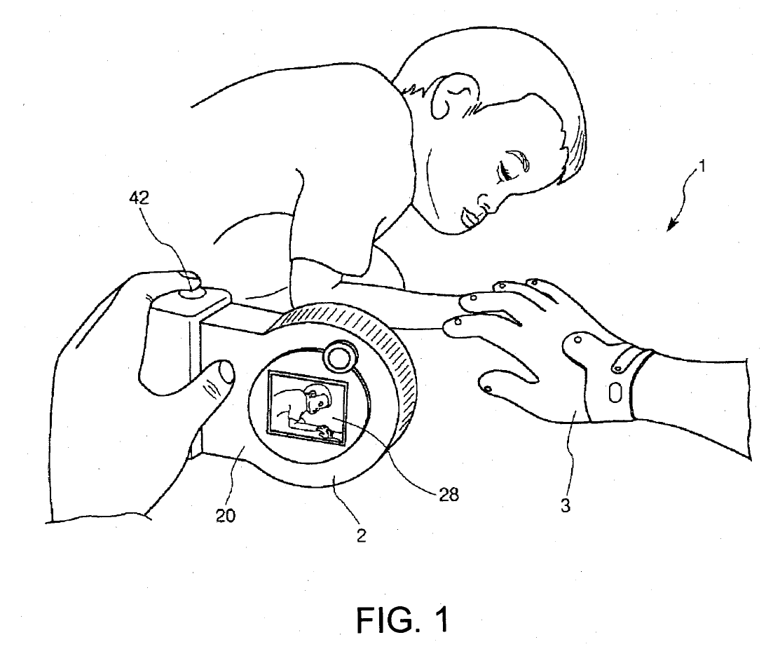

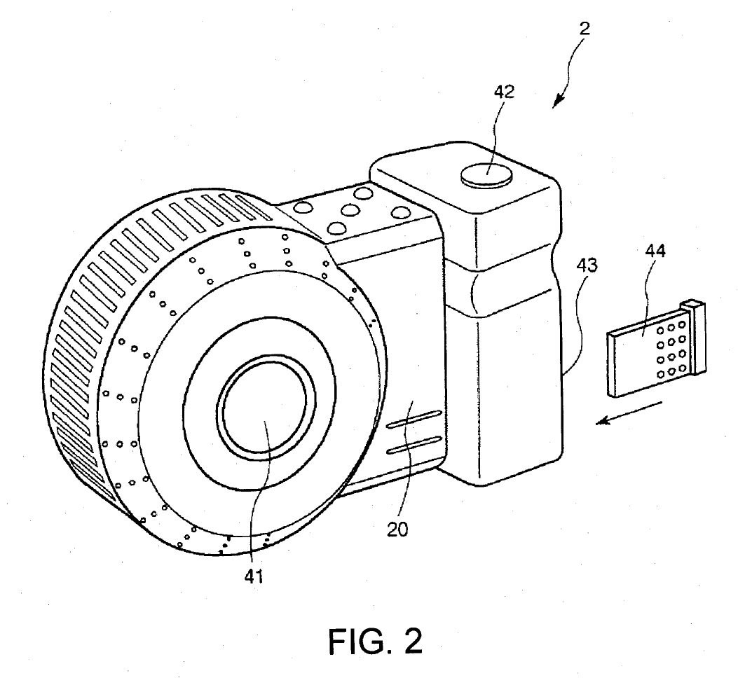

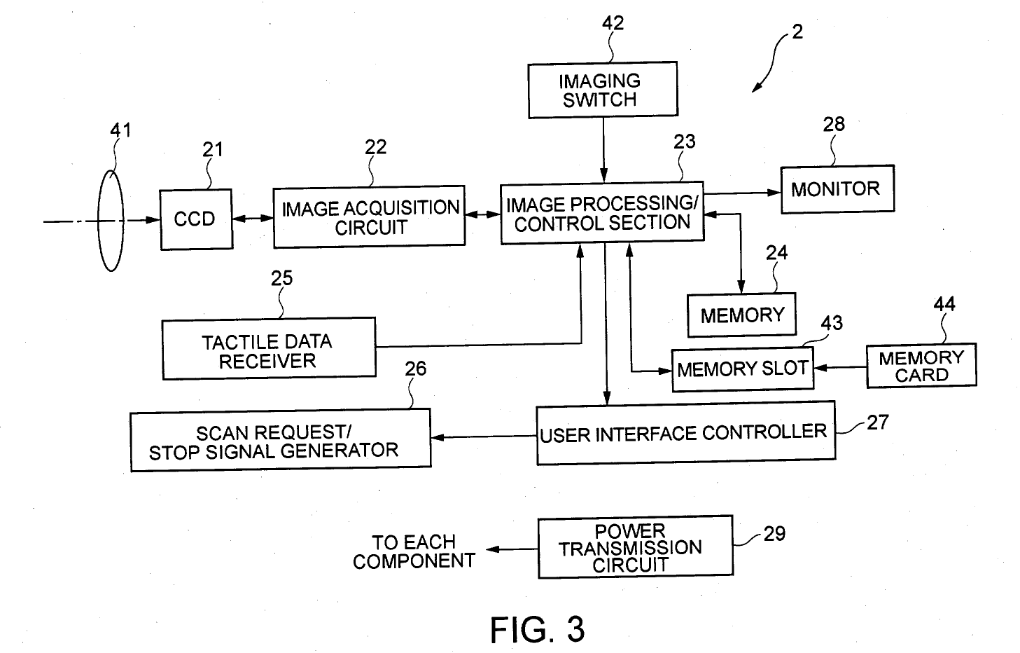

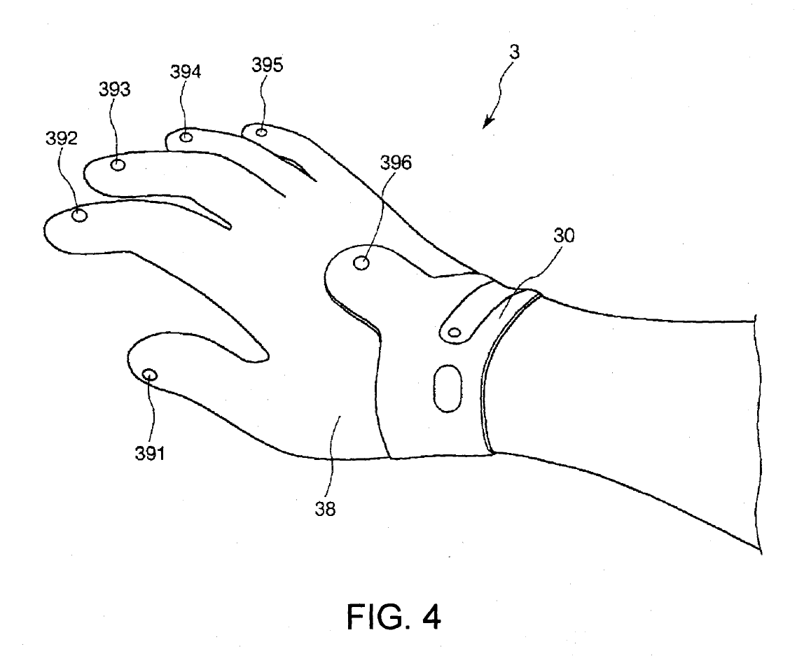

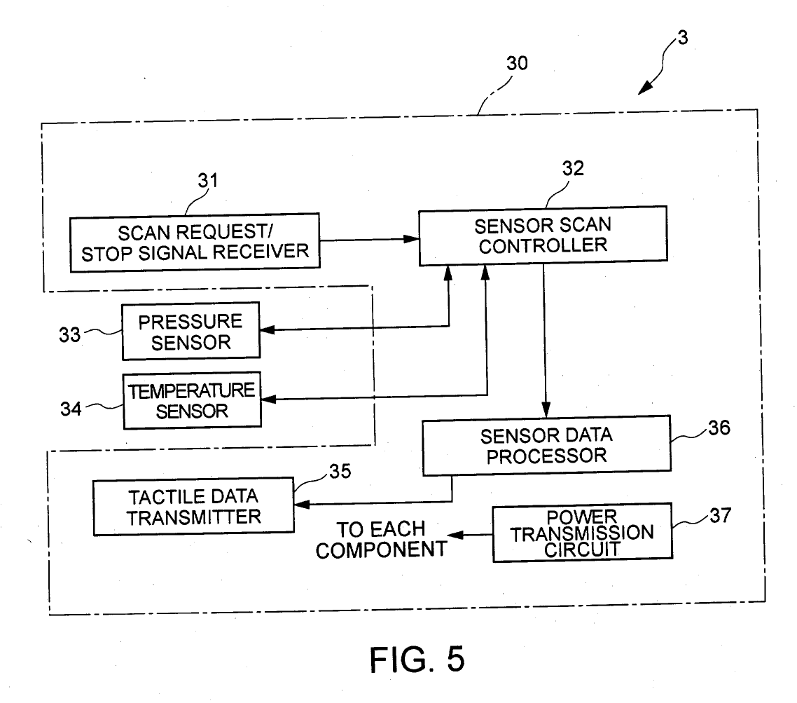

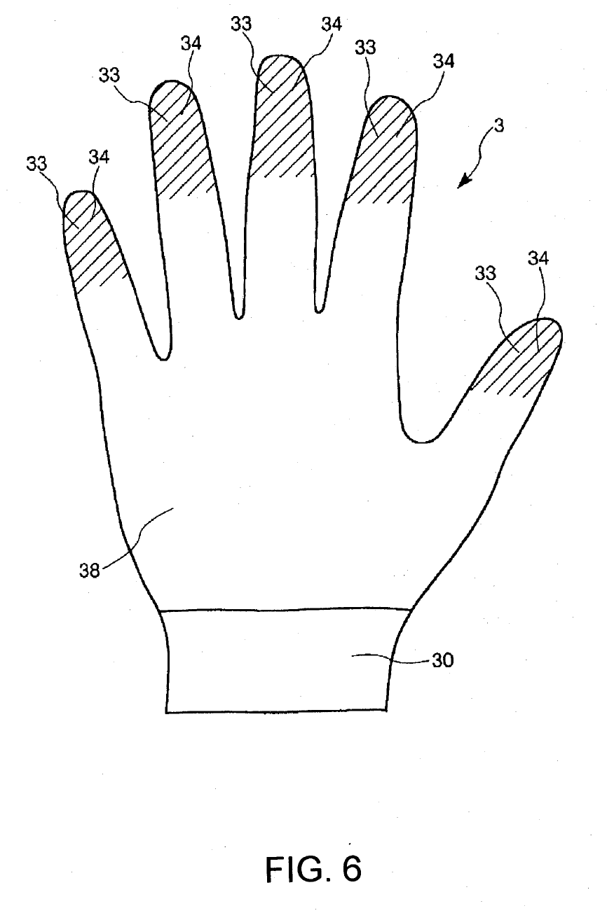

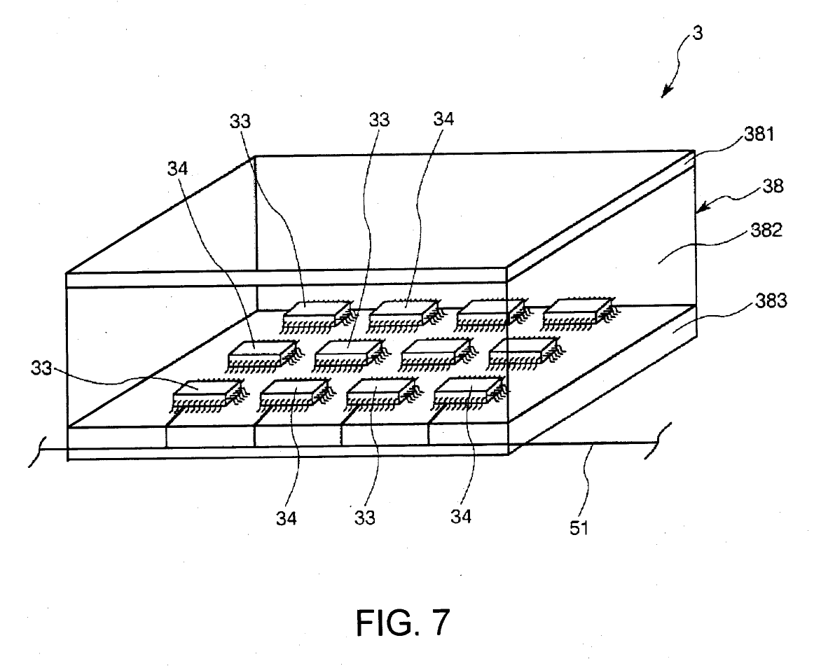

FIG. 1 is a perspective view showing an image/tactile information input device according to an embodiment of the present invention; FIG. 2 is a perspective view showing an example of the composition of a camera of the image/tactile information input device shown in FIG. 1; FIG. 3 is a block diagram showing an example of the circuitry of the camera of the image/tactile information input device shown in FIG. 1; FIG. 4 is a perspective view showing an example of the composition of a tactile glove of the image/tactile information input device shown in FIG. 1; FIG. 5 is a block diagram showing an example of the circuitry of the tactile glove of the image/tactile information input device shown in FIG. 1; FIG. 6 is a schematic diagram showing the palm of the tactile glove of the image/tactile information input device shown in FIG. 1; and FIG. 7 is a schematic diagram of sensors and the periphery of the tactile glove of the image/tactile information input device shown in FIG. 1.

An image/tactile information input device 1 shown in the drawings captures image information (image data) of an object and tactile information (tactile data) of at least one part of the object, and generates image information with tactile information (image data with tactile data) including the image information, the tactile information, and associating information (associating data) for associating the image information and the tactile information with each other.

The associating information is information (positional information) for associating the image information and the tactile information with each other, so that the image position of a particular part of the object which is imaged (photographed) as an electronic image and the tactile sense at that position correspond to each other.

The tactile sense is a sense of touch on the object, such as texture, shape, pressure (contact strength) distribution, temperature distribution, and friction distribution.

The image information with tactile information that has been generated by the image/tactile information input device 1 is inputted to, for example, an image/tactile display device (not shown). The image/tactile display device reproduces the image of the object and the tactile sense of the object on the basis of the image information with tactile information.

Since the image information with tactile information includes the associating information for associating the image information and the tactile information, the object image and the object tactile sense can be associated with each other accurately and reliably, and so the object image and the tactile sense can accurately be reproduced.

The image information with tactile information produced by the image/tactile information input device 1 may be transmitted from the image/tactile information input device 1 to the image/tactile display device, for example, by radio or wire, or may be inputted via an unloadable recording medium, or, alternatively, both are possible.

In other words, the image/tactile information input device 1 may include a communication facility (communication means) capable of performing transmission and reception (communication) of a signal to such as the image/tactile display device by radio or wire, or may be constructed (recording means may be provided) to allow recording (storing) and reproducing (reading) of information (data) to an unloadable recording medium (such as a memory card, an optical disc, a magneto-optical disk, and magnetic disk), or alternatively, both are possible.

Referring to FIG. 1, the image/tactile information input device 1 includes a camera (digital camera) 2 for imaging (photographing) an object as an electronic image and capturing the image information of the object, and a tactile glove (tactile-information acquisition means) 3 for touching at least one part of the object to capture tactile information that is the sense of touch (sense of touch by hand or fingers). The camera 2 constitutes image-information acquisition means and associating-information production means for generating associating information for associating the image information with the tactile information.

The image/tactile information input device 1, that is, the camera 2 and the tactile glove 3 have a radio communication function (radio communication means) capable of transmitting and receiving a signal by radio (radio communication) between the camera 2 and the tactile glove 3.

The communication means is not limited to radio communication but may be a cable communication between the camera 2 and the tactile glove 3.

As shown in FIGS. 1 and 2, the camera 2 has a body 20, an imaging lens (a group of imaging lenses) 41 in the front of the body 20, a monitor (display means) 28 on the back of the body 20, an imaging switch (release switch) 42 on the top of the body 20, and a memory slot (memory loading section) 43 on the side of the body 20.

An unloadable memory card (a card-shaped recording medium having a memory) 44 is loaded into the memory slot 43. When the memory card 44 is loaded in the memory slot 43, information (data) can be written (stored) to and read out from the memory card 44.

As shown in FIG. 3, the camera 2 includes a CCD (image pickup device) 21, an image acquisition circuit 22, an image processing/control section 23, a memory (such as a ROM (read-only memory), an EEPROM (electrically erasable programmable ROM), a flash memory, and a RAM (random-access memory)) 24, a tactile data receiver 25, a scan request/stop signal generator 26, a user interface controller 27, and a power transmission circuit 29 for supplying power to each component (each circuit).

The image processing/control section 23 has, for example, a microcomputer (CPU), controlling the operation of the entire camera 2 such as exposure operation, auto-exposure, automatic focusing (AF), sequence control in addition to image processing.

The memory 24, the memory slot 43, the memory card 44 and so on constitute recording means for recording image information with tactile information.

As shown in FIG. 4, the overall tactile glove 3 is shaped in the form of a glove. More specifically, the tactile glove 3 includes a glove 38, as a glove-shaped wearing means for a user (operator) to wear on a hand (from the fingers to the wrist).

The user can easily and reliably put on or off the tactile glove 3 by means of the glove 38.

The tactile glove 3 has a control unit 30 on the part corresponding to the wrist of the glove 38.

As shown in FIG. 5, the control unit 30 includes a scan request/stop signal receiver 31, a sensor scan controller 32, a tactile data transmitter 35, a sensor data processor 36, and a power transmission circuit 37 for supplying power to each component (each circuit).

With the above-described arrangement of the control unit 30, the fingers (end) of the tactile glove 3 can be decreased in weight (the inertia can be reduced), so the user can easily perform the touching action (operation).

The sensor scan controller 32 has, for example, a microcomputer (CPU), controlling the operation of the overall tactile glove 3 in addition to sensor scan processing.

As shown in FIG. 5, the tactile glove 3 includes a plurality of pressure sensors 33 for detecting pressure when it comes in contact with the object and a plurality of temperature sensors 34 for detecting temperature when it comes in contact with the object, as sensing means for detecting the tactile sense when it comes in contact with the object. By using the sensor group of the pressure sensors 33 (hereinafter, simply referred to as pressure sensors 33) and the sensor group of the temperature sensors 34 (hereinafter, simply referred to as temperature sensors 34), pressure information (pressure data) and temperature information (temperature data) are captured as tactile information (tactile data).

As shown in FIG. 6, the pressure sensors 33 and the temperature sensors 34 are arranged on the palm side of the glove 38, in regions corresponding to the finger cushions (pulp) at the tips of the fingers in this embodiment.

The regions of the pressure sensors 33 and the temperature sensors 34 are not limited to the regions in the drawing, but for example, pressure sensor 33 and the temperature sensor 34 may be provided in the front of the finger cushions of each finger of the glove 38 or, may be provided on the overall palm of the glove 38.

As shown in FIG. 7, the glove 38 of the tactile glove 3, particularly, the regions having the pressure sensors 33 and the temperature sensors 34 may be formed of a lamination layer composed of a resin film 381, a relatively soft polymer gel layer 382, and a relatively hard polymer gel layer 383.

In this arrangement, a surface side, which contacts with the object, is arranged as the outside surface. The resin film 381, the relatively soft polymer gel layer 382, and the relatively hard polymer gel layer 383 are arranged from the outside toward the inside in this order. The pressure sensors 33 and the temperature sensors 34 are mounted in the relatively soft polymer gel layer 382, that is, on the relatively hard polymer gel layer 383.

Each of the pressure sensors 33 and the temperature sensors 34 are connected to the sensor scan controller 32 via a signal line 51.

It is preferable that the number of the pressure sensors 33 and the temperature sensors 34 per unit area (density) is equal to or larger than the number of receptors such as warm spots, cold spots, and touch spots of human skin per unit area (density).

More specifically, it is preferable that the number of pressure sensors 33 per unit area (density) is equal to or larger than the number of touch spots of human skin per unit area (density). It is also preferable that the number of temperature sensors 34 per unit area (density) is equal to or larger than the number of warm spots and cold spots of human skin per unit area (density).

Accordingly, a tactile sense closer to a human sense of touch can be realized to allow proper tactile information to be acquired.

In FIG. 7, the pressure sensors 33 and the temperature sensors 34 are arranged in matrix. In the present invention, however, the arrangement of the pressure sensors 33 and the temperature sensors 34 is not limited to this configuration.

According to the invention, for example, the temperature sensors 34 may be omitted.

According to the invention, a plurality of friction sensors for detecting friction when touching the object may be arranged on the tactile glove 3 in place of the temperature sensors 34, or in addition to the pressure sensors 33 and the temperature sensors 34, with which friction information (friction data) may be acquired.

According to the invention, the sensors being used are not limited to the pressure sensors, the temperature sensors, and the friction sensors. In other words, the tactile information to be captured is not limited to the pressure information, the temperature information, and the friction information.

As shown in FIG. 4, the back of the glove 38 of the tactile glove 3 has a plurality of position markers for designating positions. Six position markers 391, 392, 393, 394, 395, and 396 are arranged in this embodiment.

The position markers 391, 392, 393, 394, and 395 are arranged at the positions that correspond to the tips of the thumb, the index finger, the middle finger, the ring finger, and the little finger of the glove 38, respectively. The position marker 396 is arranged at the position that corresponds to the center of the back of the hand of the glove 38.

The position markers 391 to 396 have respective patterns and colors capable of identifying (detecting) the respective position markers. By detecting the position markers 391 to 396, the respective positions of each of them can be detected.

Since the relationship (positional relationship) between the respective positions of the position markers 391 to 396, and the respective positions of the pressure sensors 33 and the temperature sensors 34 is known in advance, the respective positions of the pressure sensors 33 and the temperature sensors 34 can be obtained on the basis of the positional relationship and the detected positions of the position markers 391 to 396.

The action (operation) of the image/tactile information input device 1 will now be described.

Here a case in which the user (operator) captures (inputs) image information of a baby and tactile information of the hand and arm of the baby as an object using the image/tactile information input device 1, will be described.

At first, the user determines picture composition while viewing the monitor 28 and images (photographs) the object baby (for example, the lying posture of the baby) as an electronic image with the camera 2.

Accordingly, imaging is performed in the CCD 21 and a signal is outputted from the CCD 21. The signal is subjected to particular signal processing and image processing in the image acquisition circuit 22 and the image processing/control section 23, and data of the imaged electronic image, that is, image information (for example, image information of the lying posture of the baby) that is digital data, is stored in the memory 24.

The user then puts the tactile glove 3 on the hand, and touches the baby on the hand or arm with the tactile glove 3. The user may not only touch but may pat his/her hand on the baby.

The user, for example, determines composition while viewing the monitor 28 and images the state in which he/she touches the baby on the hand or arm with the tactile glove 3 (the tactile glove 3 and the hand or arm of the baby) as an electronic image with the camera 2.

In this manner, imaging is performed in the CCD 21 and a signal is outputted from the CCD 21. The signal is subjected to particular signal processing and image processing in the image acquisition circuit 22 and the image processing/control section 23, and data of the imaged electronic image, that is, the image information of the state in which the user touches the baby on the hand or arm with the tactile glove 3 (the tactile glove 3 and the hand or the arm of the baby) is stored in the memory 24.

The tactile glove 3 sequentially detects the pressure and the temperature when the user touches (or pats) the baby on the hand or arm with the pressure sensors 33 and the temperature sensors 34 by the control of the sensor scan controller 32. In other words, the pressure information and the temperature information are captured. It is possible to determine from which sensor, the pressure sensors 33 the temperature sensors 34, the value (data) came.

Imaging of the tactile glove 3 and the hand or arm of the baby when the user touches the baby on the hand or arm with the tactile glove 3 is performed when the pressure information and the temperature information are captured.

Data of the pressure and data on the temperature, detected by the pressure sensors 33 and the temperature sensors 34, are processed by the sensor data processor 36, and they are then transmitted from the tactile data transmitter 35 to the camera 2. In other words, the pressure information and the temperature information are transmitted from the tactile data transmitter 35 of the tactile glove 3 to the camera 2.

The pressure information and the temperature information are received by the tactile data receiver 25 of the camera 2, and are stored in the memory 24 via the image processing/control section 23.

The image processing/control section 23 of the camera 2 produces associating information for associating image information of the baby and the pressure information and the temperature information (tactile information) so that the image (electronic image) position of a particular region of the baby and the pressure and the temperature (tactile sense) in that position correspond to each other. Thereby image information with tactile information including the image information of the baby, the pressure information and the temperature information, and the associating information is generated.

In this case, at first, the image processing/control section 23 obtains the position of the region of the hand or arm of the baby to capture the pressure information and the temperature information on the basis of the image information on the tactile glove 3 and the hand or arm of the baby when the user touches the baby on the hand or arm with the tactile glove 3, and generates associating information on the basis of the obtained positional information.

The image of the tactile glove 3 and the hand or arm of the baby when the user touches the baby on the hand or arm with the tactile glove 3 includes the images of the position markers 391 to 396. The respective positions of the pressure sensors 33 and the temperature sensors 34 can be obtained by means of the position markers 391 to 396, as described above. Also, it is possible to determine which sensor, of the pressure sensors 33 and the temperature sensors 34, the value (data) came from. Thus, the associating information can be produced.

The image processing/control section 23 generates image information with tactile information by composing image information of the baby, pressure information and temperature information, and associating information (composing the image position of a particular region of the baby and the pressure and the temperature at the position so that they can correspond to each other in data). The image information with tactile information is stored in the memory 24 and the memory card 44.

The image information with tactile information may separately include, for example, image information, pressure information and temperature information (tactile information), and associating information or, alternatively, any two of the image information, the pressure information and the temperature information (tactile information), and the associating information may be combined.

In this embodiment, after the image information has been captured, the tactile information is captured. In the present invention, however, the image information may be captured after the tactile information has been captured.

According to the invention, for capturing the tactile information, the number of times and the way of touching the object with the tactile glove 3 are not particularly limited. For example, it is also possible to touch the object once with the tactile glove 3 and to image it with the camera 2. Alternatively, it is also possible to touch the object a plurality of times with the tactile glove 3 and to image it with the camera 2 each time.

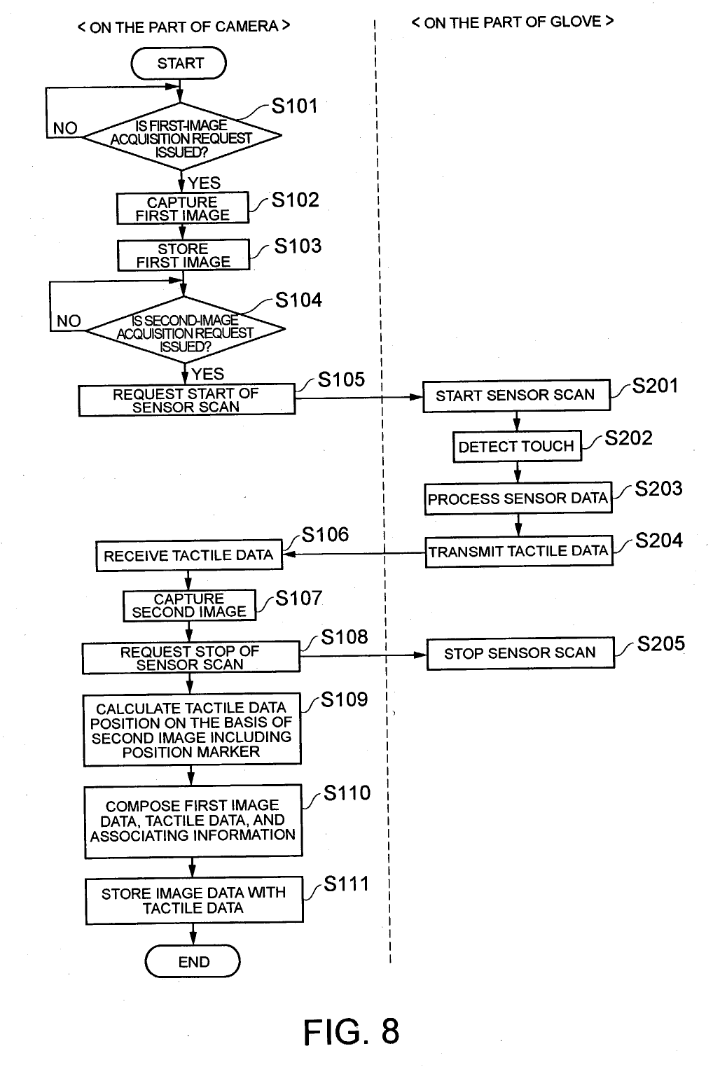

Next, Referring to the flowchart of FIG. 8, the operation of the image/tactile information input device 1 will be specifically described.

The program for implementing the functions described in the flowchart is stored (recorded) in the memory (recording medium) 24 of the camera 2 or a recording medium (a nonvolatile memory or the like such as a ROM, a flash memory, and an EEPROM, not shown here) of the tactile glove 3 in the form of a program code which can be read by the computer. The camera 2 (image processing/control section 23) and the tactile glove 3 (sensor scan controller 32) execute the operation in sequence according to the program code.

The program may be stored only in the camera 2, or only in the tactile glove 3; alternatively, the programs may be stored in both the camera 2 and the tactile glove 3.

FIG. 8 is a flowchart showing an example of the operation of the image/tactile information input device 1 when image information and tactile information are captured. The left side in FIG. 8 shows the processing of camera 2, and the right side in FIG. 8 shows the processing of tactile glove 3.

At first, the user images the object (such as a baby) as an electronic image with the camera 2. In this case, the user determines the picture composition while viewing the electronic image of the object on the monitor 28, for example, and then turns on the imaging switch 42.

As shown in FIG. 8, it is determined in the camera 2 as to whether a first-image acquisition request has been issued (step S101). When it is determined that the first-image acquisition request has been issued, the first image is imaged (step S102).

By turning on the imaging switch 42 of the camera 2, the first-image acquisition request is issued.

The imaged first image data is then stored in the memory 24 (step S103).

The user then images the object and the tactile glove 3 as an electronic image with the camera 2 while touching the object with the tactile glove 3. In this case, the user determines the picture composition while viewing the electronic image of the object and the tactile glove 3 on the monitor 28 and turns on the imaging switch 42.

It is determined in the camera 2 as to whether a second-image acquisition request has been issued (step S104). When it is determined that the second-image acquisition request has been issued, a sensor-scan start request is issued (step S105).

By turning on the imaging switch 42 of the camera 2, the second-image acquisition request is issued.

In the step S105, a scan request/stop signal generator 26 generates a scan request signal via the user interface controller 27, and the scan request signal is transmitted from the scan request/stop signal generator 26 to the tactile glove 3.

The scan request signal is received by the scan request/stop signal receiver 31 of the tactile glove 3 and is inputted to the sensor scan controller 32.

When the scan request signal is inputted, the sensor scan controller 32 starts sensor scanning of the pressure sensors 33 and the temperature sensors 34 (step S201), detects touch (step S202), processes sensor data (step S203), and transmits tactile data (step S204).

In the steps S201 to S204, as described above, the pressure sensors 33 and the temperature sensors 34 sense the pressure and the temperature in sequence by the control of the sensor scan controller 32. The detected data on the detected pressure and the data on the detected temperature are processed by the sensor data processor 36, and tactile data composed of the obtained pressure data and temperature data (hereinafter, simply referred to as tactile data) is transmitted from the tactile data transmitter 35 to the camera 2.

The tactile data is received by the tactile data receiver 25 of the camera 2 (step S106), and is inputted to the image processing/control section 23.

Subsequently, the second image is imaged (step S107).

Thereafter, a sensor-scan stop request is issued (step S108).

In the step S108, a scan stop signal is produced by the scan request/stop signal generator 26 via the user interface controller 27, and the scan stop signal is transmitted from the scan request/stop signal generator 26 to the tactile glove 3.

The scan stop signal is received by the scan request/stop signal receiver 31 of the tactile glove 3 and is inputted to the sensor scan controller 32.

When the scan stop signal is inputted, the sensor scan controller 32 stops the sensor scanning (step S205). Accordingly, the processing of the tactile glove 3 is terminated.

The process of the camera 2 proceeds to step 109 after the step S108, obtains the respective positions of the object that has imported the tactile data on the basis of the second image data including the position markers 391 to 396, and performs tactile-data position calculating processing for producing associating information on the basis of the obtained positional information (step S109).

Subsequently, the first image data, the tactile data, and the associating information are composed (step S110).

Accordingly, the image data with tactile data can be obtained, which is a combination of the first image data, the tactile data, and the associating information.

The image information with tactile information is then stored in the memory 24 and the memory card 44 (step S111).

This program is then terminated.

As described above, according to the image/tactile information input device 1, the image/tactile information input method, and the image/tactile information input program, the image information of the object and tactile information can be obtained such that they are associated with each other.

Since the object is imaged as an electronic image and is then captured as image information, the image information can be obtained accurately.

Since tactile information is captured by touching the object, the tactile information can be obtained accurately.

When the object image and the object tactile sense are individually reproduced on a particular image/tactile display on the basis of the image information with tactile information that has been produced by the image/tactile information input device 1, since the image information with tactile information includes associating information for associating the image information and the tactile information, the object image and the object tactile sense can be corresponded to each other accurately and reliably, and so the object image and tactile sense can be reproduced accurately.

The image/tactile information input device, the image/tactile information input method, and the image/tactile information input program according to the invention have been described in accordance with the embodiment in the drawings, it is to be understood that the invention is not limited to that, but the arrangement of the components can be replaced with any other arrangements with similar functions.

According to the embodiment, the tactile-information acquisition means captures a sense of touch (tactile information) from the object by hand or fingers. According to the invention, however, it is not limited to that but a sense of touch (tactile information) from the object by leg or other regions, which touches the object, may be acquired.

According to the embodiment, the object is a baby (living body). However, the object is not limited to a living body but may be everything including material objects.

Advantage of the Invention

According to the invention, the image information and tactile information of the object can be associated with each other and can be obtained accurately, as described above.

When the object image and the object tactile sense are individually reproduced on a particular image/tactile display device on the basis of the obtained image information with tactile information, since the image information with tactile information includes associating information for associating the image information and the tactile information, the object image and the object tactile sense can be corresponded to each other accurately and reliably, and so the object image and tactile sense can be reproduced accurately.

The entire disclosure of Japanese Patent Application No. 2002-178626 filed Jun. 19, 2002 is incorporated by reference.

1. An image/tactile information input device comprising:
image-information acquisition means for imaging an object as an electronic image to capture image information of the object;
tactile-information acquisition means for touching at least one part of the object to capture tactile information; and
associating-information production means for producing associating information associating the image information and the tactile information with each other so that an image position of a particular part of the object and a tactile sense at the position correspond to each other;
wherein image information with tactile information including the image information, the tactile information, and the associating information is produced.

2. An image/tactile information input device according to claim 1, wherein:
the input device obtains the position of the tactile-information acquisition part of the object when capturing the tactile information; and
the associating information is produced on the basis of the obtained positional information.

3. An image/tactile information input device according to claim 1, wherein:
the input device images the tactile-information acquisition means and the object as an electronic image by the image-information acquisition means, and obtains the position of the tactile-information acquisition part of the object on the basis of the image information on the tactile-information acquisition means and the object when capturing the tactile information; and
the associating information is produced on the basis of the obtained positional information.

4. An image/tactile information input device according to claim 2, wherein:
the tactile-information acquisition means includes at least one position marker designating a particular position of the tactile-information acquisition means; and
the position of the tactile-information acquisition part of the object is obtained using the position marker.

5. An image/tactile information input device according to claim 1, wherein the tactile-information acquisition means includes a plurality of pressure sensors for detecting pressure when the object is touched.

6. An image/tactile information input device according to claim 5, wherein the tactile-information acquisition means includes a plurality of temperature sensors for detecting temperature when the object is touched.

7. An image/tactile information input device according to claim 1, wherein the tactile-information acquisition means includes a glove-shaped wearing means for wearing on a hand.

8. An image/tactile information input device according to claim 1, wherein the tactile information includes pressure information.

9. An image/tactile information input device according to claim 8, wherein the tactile information further includes temperature information.

10. An image/tactile information input device according to claim 8, wherein the tactile information further includes friction information.

11. An image/tactile information input device according to claim 1, wherein the image information and the tactile information are separately captured.

12. An image/tactile information input device according to claim 1, wherein the image information with tactile information is composed of the image information, the tactile information, and the associating information.

13. An image/tactile information input device according to claim 1, wherein the image information with tactile information separately includes the image information, the tactile information, and the associating information.

14. An image/tactile information input device according to claim 1, comprising recording means for recording the image information with tactile information.

15. An image/tactile information input method comprising the steps of:
imaging an object as an electronic image to capture image information of the object;
touching at least one part of the object to capture tactile information;
producing associating information associating the image information and the tactile information with each other so that an image position of a particular part of the object and a tactile sense at the position correspond to each other; and
producing image information with tactile information including the image information, the tactile information, and the associating information.

16. An image/tactile information input program for operating a computer comprising:
image-information acquisition means for imaging an object as an electronic image to capture image information of the object;
tactile-information acquisition means for touching at least one part of the object to capture tactile information;
associating-information production means for producing associating information associating the image information and the tactile information with each other so that an image position of a particular part of the object and a tactile sense at the position correspond to each other; and
means for producing image information with tactile information including the image information, the tactile information, and the associating information.
